(19) United States
(12) Patent Application Publication
(10) Pub. No.: US 2024/0126838 A1
(43) Pub. Date: Apr. 18, 2024

(54) AUTOMATED ANNOTATION OF DATA FOR MODEL TRAINING

(71) Applicant: SAP SE, Walldorf (DE)

(72) Inventors: Komal NARSINGHANI, Bangalore (IN); E. Aruna DEVI, Chennai (IN)

(21) Appl. No.: 17/967,975

(22) Filed: Oct. 18, 2022

(51) Int. Cl. G06K 9/62

(52) U.S. Cl. CPC G06K 9/6257

(57) ABSTRACT

Systems and methods provide reception of a plurality of data samples for training a machine learning model and a plurality of examples associated with each of a plurality of ground truth labels for training a machine learning model, identification of all examples of the plurality of examples within each of the data samples, determination, for each identified example, of an associated one of the plurality of labels and a location of the example in the data sample, annotation of the data sample with the associated one of the plurality of labels and the location, and training of a machine learning model using the annotated data sample.

### BACKGROUND

Software applications, executed on-premise or in the cloud, are used to automate tasks which were previously performed manually. Conventionally, such automations were limited since many manual tasks include a degree of judgment which cannot be easily represented in software. However, improvements in machine learning have increased the types of tasks which may be reliably performed by software applications. This is primarily due to the fact that a software developer need not develop and code logic for performing such a task, but must simply use training data to train a machine learning model to perform the task. Once trained, the machine learning model may be operated to perform the task on new input data.

Supervised machine learning is a type of model training which uses training data consisting of data samples and associated ground truths. For example, if each data sample is a row of sales data, a profit value may be the ground truth associated with each row. Data samples are input to a machine learning model, which generates an output (a value, a classification, etc.) for each sample. The outputs are compared with the ground truths corresponding to each input data sample and the model is modified based on the comparison. The process repeats until the outputs of the model match the ground truths to a suitable degree.

Modern software services allow users to train their own machine learning models which are specific to the use-cases they wish to address. In order train such a model using a supervised machine learning algorithm, the user must provide data samples and one or more labels, or ground truths, for each data sample. Moreover, the data samples and labels (i.e., the training data) must be provided in a format which can be understood by the supervised machine learning algorithm. The creation of training data consisting of formatted data samples and labels is referred to as annotation.

Annotation of data for model training is typically performed by a human. Due to the large number of data samples of which training data typically consists, annotation is an extremely time- and resource-consuming process. Moreover, human-performed annotation of large sets of training data is prone to errors. Such errors within training data may lead to deficiencies in any machine learning model which is trained based thereon.

Systems are desired to improve the efficiency and accuracy of data annotation for use in creating training data for machine learning models.

### BRIEF DESCRIPTION OF THE DRAWINGS

FIG. 1 is a block diagram of an architecture to provide data annotation for model training according to some embodiments.

FIG. 2 illustrates textual data samples according to some embodiments.

FIG. 3 illustrates files including examples associated with two different annotation labels according to some embodiments.

FIG. 4 illustrates training data annotated according to some embodiments.

FIG. 5 is a flow diagram of a process to generate annotated data for model training according to some embodiments.

FIG. 6 is a block diagram of an architecture including data annotation, model training and model inferences within a machine learning service according to some embodiments.

FIG. 7 is a block diagram of a cloud-based architecture implementing a system according to some embodiments.

### DETAILED DESCRIPTION

The following description is provided to enable any person in the art to make and use the described embodiments. Various modifications, however, will remain readily-apparent to those in the art.

Some embodiments provide an automated system to create training data based on data samples and files which include examples associated with various annotation labels. Such training data may conform to a specified format expected by a model training service which is to consume the training data. In one non-exhaustive example provided below, each text data sample of training data is succeeded by indices identifying a location of characters within the text and a label associated with those characters.

Some embodiments implement data annotation as a service using a set of Application Programming Interfaces (APIs). The APIs may be called to transmit data samples and files as described above and to initiate annotation based thereon. If the APIs are provided by a machine learning service, other APIs of the machine learning service may be called to initiate training of a particular model based on the thusly-annotated data. Additionally, the machine learning service may provide inference APIs which can be called to request an inference from a trained model based on an input data sample.

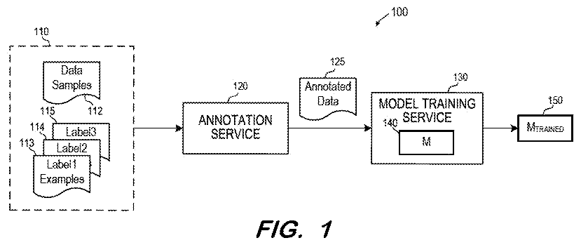

FIG. 1 is a block diagram of architecture 100 to provide model training according to some embodiments. Architecture 100 is a logical architecture and may be implemented any suitable combination of computing hardware and/or processor-executable program code that is or becomes known. Such combinations may include one or more programmable processors (microprocessors, central processing units, microprocessor cores, execution threads), one or more non-transitory electronic storage media, and processor-executable program code. In some embodiments, two or more elements of architecture 100 are implemented by a single computing device, and/or two or more elements of architecture 100 are co-located. One or more elements of architecture 100 may be implemented as a cloud service (e.g., Software-as-a-Service, Platform-as-a-Service) using cloud-based resources, and/or other systems which apportion computing resources elastically according to demand, need, price, and/or any other metric.

Briefly, input data 110 is provided to annotation service 120. Annotation service generates annotated data 125, or training data, based on input data 110. Annotated data 125 is used by model training service 130 to train machine learning model 140, resulting in trained machine learning model 150.

Input data 110 includes data samples 112 and label examples 113-115. Data samples 112 include one or more instances data of a type which is expected to be received by trained model 150. For example, data samples 112 may include text of e-mail bodies, resumes, receipts, etc.

Each of label examples 113-115 provides, for a given respective label, a list of one or more examples of text associated with the respective label. As will be described below, Label1 examples 113 may be associated with the label FirstName and may include a list of first (i.e., given) names. Similarly, label2 examples 114 may be associated with the label LastName and may include a list of last (i.e., family) names.

Input data 110 may be received from disparate sources and compiled by a machine learning model administrator. Input data 110 may be provided to annotation service 120 within any number of data files. In some embodiments, each of data samples 112 and label examples 113-115 are provided to annotation service 120 as separate files. As will be described below, a machine learning service may provide APIs facilitating the uploading of input data to annotation service 120.

Annotation service 120 identifies examples of labels, if any, within each of data samples 112 based on label examples 113-115, and annotates each data sample 112 with the labels identified therein. The annotation may conform to a predetermined format suitable for input to model training service 130. According to some embodiments and as will be described below, each label added to a data sample is accompanied by a start index and an end index indicated a starting and ending position of the example of the label within the data sample. Annotation service 120 may be implemented using executable program code such as, for example, a Python script. Annotation service 120 may be executed by a cloud-based application server (e.g., a virtual machine) or by any suitable computing system.

Model training service 130 may provide training of one or more selectable models based on annotated data. Annotated data 125 may be received by model training service 130 from annotation service 120 or from a user who submitted input data 110 to annotation service 120, for example. Model training service 130 may receive annotated data 125 along with identification of a model M 140 to be trained based on annotated data 125. Model training service 130 may also be executed by a cloud-based application server or by any suitable computing system, including the same server or system which executes annotation service 120.

The models of model training service 130 are capable of locating and labelling specific text within text data. Each model is associated with respective hyperparameters defining the node layers thereof. Model training service 130 may train models based on respective initial node and objective functions using supervised learning algorithms as is known. In one example, labeled text output by a model based on each data sample of annotated data 125 is compared to the “ground truth” label(s) associated with that data sample within annotated data 125, and internal node weights of the model are adjusted until an aggregated difference, or total loss, between the outputs and the ground truths is below a threshold.

Trained machine learning model 150 may be implemented in program code and may comprise any implementation of a trained machine learning model that is or becomes known. In some embodiments, users and/or applications may use trained model 150 to generate inferences. For example, model training service 130 may also provide APIs which can be called to transmit data and select trained model 150. In response to such a call, service 130 inputs the data to trained model 150, receives output therefrom, and returns the output (i.e., the inference).

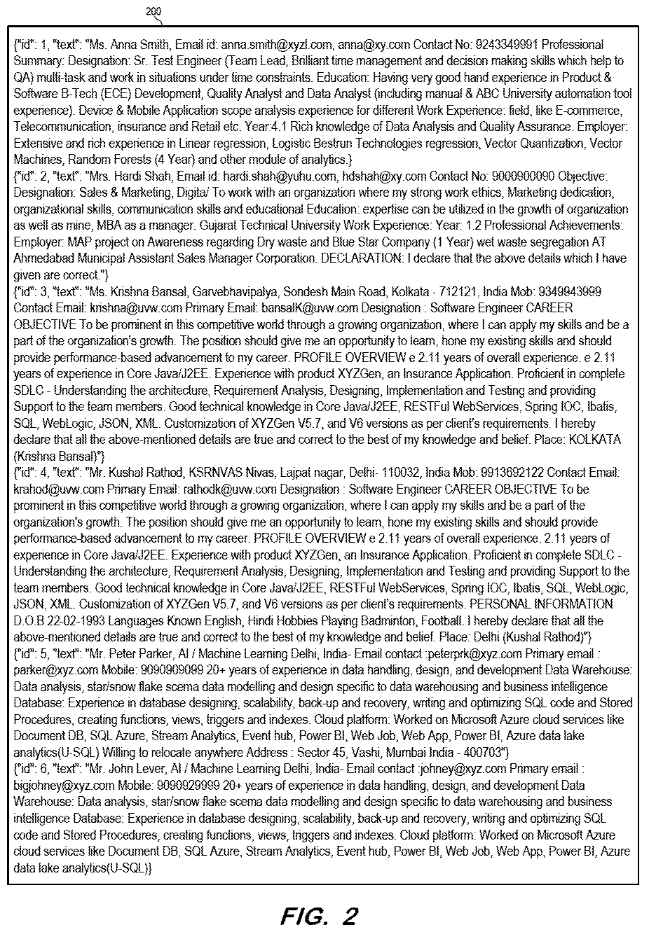

FIG. 2 illustrates file 200 including textual data samples according to some embodiments. Each of the six textual data samples of file 200 is enclosed within brackets “{ }” and is associated with an id and a type “text”. Each of the data samples may comprise text extracted from a respective resume, but embodiments are not limited thereto.

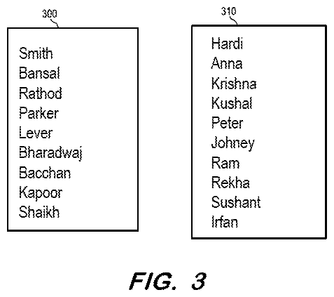

Continuing the present example, FIG. 3 illustrates label examples 300 and 310. Each of label examples 300 and 310 may comprise a separate .txt file. The examples of file 300 are examples text which should be labeled “Last_Name” and the examples of file 310 are examples of text which should be labeled “First_Name”. In some embodiments, the label associated with the examples of a file is provided in the filename of the file. For example, file 300 may be named “label_Last_Name.txt” and file 310 may be named label_First_Name.txt”. The foregoing naming scheme may facilitate recognition of the file by annotation service 120 as including examples of a label, as well as providing the name of the label to annotation service 120.

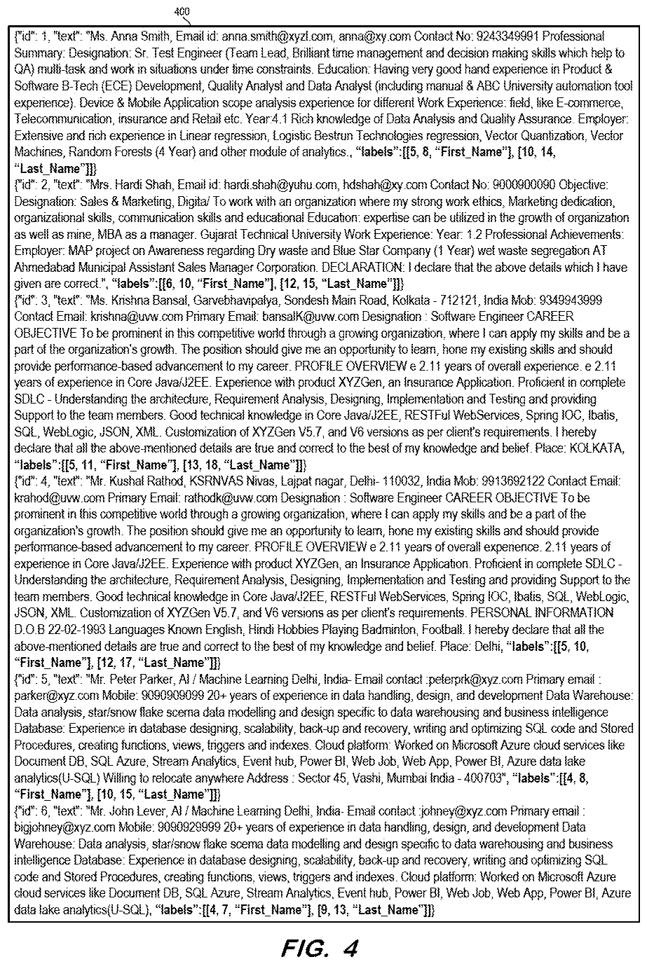

FIG. 4 illustrates annotated data 400 according to some embodiments. Annotated data 400 is based on files 200, 300 and 310 of FIGS. 2 and 3. In the present example, annotated data 400 is identical to file 200 except for the appending of annotations (shown in bold) to the end of each data sample. As mentioned above, each annotation appended to the end of a data sample includes a label and start and end indices indicating a starting and ending position of an example of the label within the data sample. For example, annotated data 400 appends an annotation to the data sample having id=1 which indicates that the text located from the fifth through eighth positions of the data sample (i.e., “Anna”) is associated with the label First_Name. Additionally, the annotation indicates that the text located from the tenth through fourteenth positions of the data sample (i.e., “Smith”) is associated with the label Last_Name.

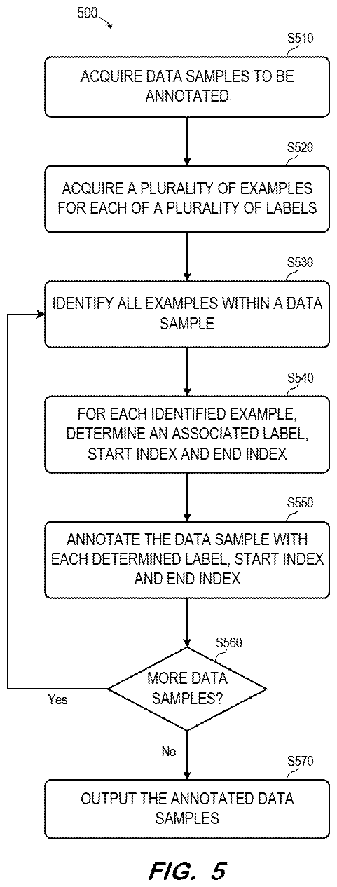

FIG. 5 is a flow diagram of process 500 to generate annotated data for training a machine learning model using supervised learning according to some embodiments. Data samples to be annotated are acquired at S510. The data samples may be acquired from any number of disparate sources, including but not limited to data generated and stored by an application in a productive system. Some or all of the data samples may be generated explicitly for use in process 500. In some embodiments, some or all of the data samples are acquired via an API call which provides the data samples to a component executing process 500 (e.g., annotation service 120).

Next, at S520, a plurality of examples associated with each of a plurality of labels are acquired. The plurality of examples may be acquired by means of an API which a client component uses to transmit files including the plurality of examples to a component such as annotation service 120. Each of the plurality of examples associated with a given label represents a word which should be identified with the given label during annotation.

Accordingly, at S530, all examples from the plurality of the examples which exist in a first data sample are identified. For each identified example, an associated label, a start index and an end index are determined at S540. According to some embodiments, S530 and S540 are executed by reading the contents of the first data sample and files including the plurality of examples per the following pseudocode:

```
file_obj = open(file_path, “r”)
  words = file_obj.read( ).splitlines( )
  file_obj.close( )
```

Next, each sentence of the data sample is iterated through to find exact matches to label example, the start and end indices of those matches. This operation according to some embodiments is represented by the following pseudocode:

```
for label_list in labels:
  for word in labels[label_list]:
    if word in sentence:
      internal_dict[“text”] = sentence
      start_index = sentence.find(word)
      end_index = (start_index + len(word)) − 1
```

The data sample is then annotated at S550 with the determined label, the start index and the end index. The following pseudocode represents writing the annotated data sample to a JSON file, but embodiments are not limited thereto:

output_file = current_file_path + “/” + job_id + “/output_file.json”
with open(output_file, “a”) as file:
file.write(json.dumps(internal_dict) + ‘\n’)

At S560, it is determined whether any more of the data samples acquired at S510 remain to be annotated. If so, flow returns to S530 and proceeds as described above to annotate a next data sample. Flow proceeds from S560 to S570 once it is determined that of the data samples acquired at S510 have been annotated.

The annotated data samples are output at S570. In some embodiments, the annotated data samples are returned to the user from whom the data samples and plurality of examples were acquired. The annotated data samples may be output at S570 to a machine learning model training service to train a machine learning model based on the annotated data. Output to a machine learning model training service may proceed as follows in some embodiments:

output_file_path = current_file_path + “/” + job_id +
“/output_file.json”
from flask import send_file
return send_file(output_file_path, as_attachment=True)

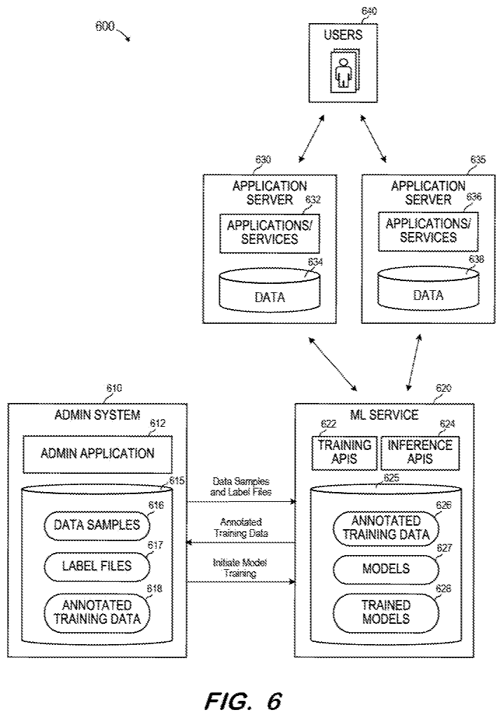

FIG. 6 is a block diagram of architecture 600 to generate training data for training machine learning models which may be used by disparate applications or services according to some embodiments.

Administrator system 610 includes administrator application 612 and storage system 615. An administrator may operate administrator system 610 to execute administrator application 612 so as to provide data samples 616 and label files 617 to machine learning service 620. In this regard, administrator application 612 may call one or more APIs of training APIs 622 of ML service 620 to transmit data samples 616 and label files 617 thereto.

Machine learning service 620, in turn, executes corresponding APIS 622 to generate annotated training data based on the received data samples 616 and label files 617 as described herein. The annotated training data may be stored in storage system 625 as annotated training data 626 and/or returned to administrator system 610 and stored therein as annotated training data 618.

An administrator may further operate administrator application 612 to initiate model training based on annotated training data 618. For example, administrator application 612 may call one or more APIs of training APIs 622 to specify a model of models 627 and to request training of the specified model using annotated training data 618. In response, machine learning service 620 trains the specified model, resulting in a trained model. The trained model is stored among other trained models 628 stored by machine learning service 620.

Application servers 630 and 635 execute applications and/or services 632 and 636, respectively, based on respective data 634 and 638. Users 640 operate computing devices as is known in the art to access the functionality of execute applications and/or services 632 and 636. To provide this functionality, execute applications and/or services 632 and 636 may request inferences from machine learning service 620 based on trained models 628. An inference request may comprise calls to one or more inference APIs 624 of machine learning service 620 which include an identifier of a trained model and input data suitable for that model.

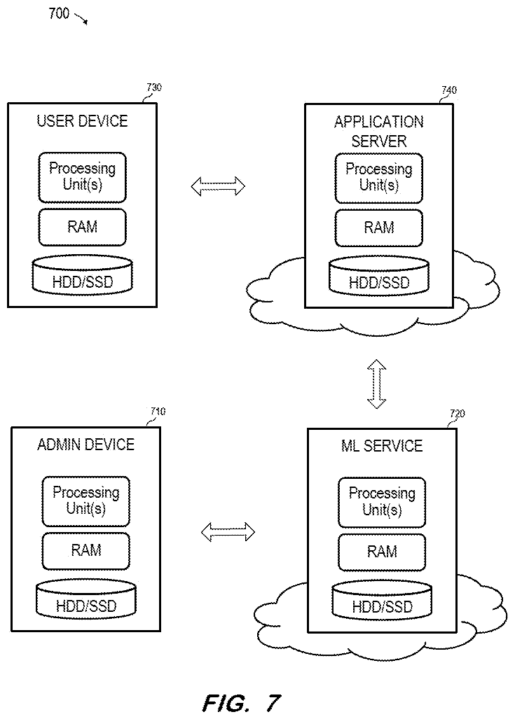

FIG. 7 is a block diagram of cloud-based architecture 700 implementing a system according to some embodiments. Administrator device 710 may provide data samples and label examples to machine learning service 720, and machine learning service 720 may annotate the data samples to create training data as described herein. Administrator device 710 may also request machine learning service 720 to train a model based on the training data.

A user may operate user device 730 to interact with user interfaces of a service or application provided by application server 740, which in turn requests inferences from trained models of machine learning service 720. Each of these services or applications may operate in conjunction with data stored local and/or on one or more remote data storage systems (not shown). Machine learning service 720 and application server 730 may comprise cloud-based compute resources, such as one or more virtual machines, allocated by a public cloud provider providing self-service and immediate provisioning, autoscaling, security, compliance and identity management features.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of architectures described herein may include at least one processing unit to execute program code such that the computing device operates as described herein.

All systems and processes discussed herein may be embodied in program code stored on one or more non-transitory computer-readable media. Such media may include, for example, a DVD-ROM, a Flash drive, magnetic tape, and solid-state Random Access Memory (RAM) or Read Only Memory (ROM) storage units. Embodiments are therefore not limited to any specific combination of hardware and software.

Elements described herein as communicating with one another are directly or indirectly capable of communicating over any number of different systems for transferring data, including but not limited to shared memory communication, a local area network, a wide area network, a telephone network, a cellular network, a fiber-optic network, a satellite network, an infrared network, a radio frequency network, and any other type of network that may be used to transmit information between devices. Moreover, communication between systems may proceed over any one or more transmission protocols that are or become known, such as Asynchronous Transfer Mode (ATM), Internet Protocol (IP), Hypertext Transfer Protocol (HTTP) and Wireless Application Protocol (WAP).

Embodiments described herein are solely for the purpose of illustration. Those in the art will recognize other embodiments may be practiced with modifications and alterations to that described above.

What is claimed is:

1. A system comprising:
a storage device; and
at least one processing unit to execute processor-executable program code stored on the storage device to cause the system to:
receive a plurality of data samples for training a machine learning model;
receive a plurality of examples associated with each of a plurality of ground truth labels for training the machine learning model;
for each of the plurality of data samples:
identify all examples of the plurality of examples within the data sample;
for each identified example, determine an associated one of the plurality of labels and a location of the example in the data sample, and
annotate the data sample with the associated one of the plurality of labels and the location; and
return the annotated data sample.

2. A system according to claim 1, wherein determination of the location comprises determination of a start index and an end index of the example within the data sample, and wherein the data sample is annotated with the start index and the end index.

3. A system according to claim 1, wherein the plurality of data samples are received via a first application programming interface, and
wherein the plurality of examples associated with each of a plurality of labels are received via a second application programming interface.

4. A system according to claim 3, wherein the plurality of data samples are received within a first file, and
wherein the plurality of examples associated with each of the plurality of labels are received in a plurality of files, where each of the plurality of files includes the plurality of examples of only one label.

5. A system according to claim 4, wherein the filename of each of the plurality of files including the plurality of examples of only one label comprises the label.

6. A system according to claim 1, wherein the plurality of examples associated with each of the plurality of labels are received in a plurality of files, where each of the plurality of files includes the plurality of examples of only one label.

7. A system according to claim 6, wherein the filename of each of the plurality of files including the plurality of examples of only one label comprises the label.

8. A computer-implemented method comprising:
receiving a plurality of data samples for training a machine learning model and a plurality of examples associated with each of a plurality of ground truth labels for training the machine learning model;
for each of the plurality of data samples:
identifying all examples of the plurality of examples within the data sample;
for each identified example, determining an associated one of the plurality of labels and a location of the example in the data sample, and
annotating the data sample with the associated one of the plurality of labels and the location; and
training a machine learning model using the annotated data sample.

9. A method according to claim 8, wherein determining the location comprises determining a start index and an end index of the example within the data sample, and wherein the data sample is annotated with the start index and the end index.

10. A method according to claim 8, wherein the plurality of data samples are received via a first application programming interface, and
wherein the plurality of examples associated with each of a plurality of labels are received via a second application programming interface.

11. A method according to claim 10, wherein the plurality of data samples are received within a first file, and
wherein the plurality of examples associated with each of the plurality of labels are received in a plurality of files, where each of the plurality of files includes the plurality of examples of only one label.

12. A method according to claim 11, wherein the filename of each of the plurality of files including the plurality of examples of only one label comprises the label.

13. A method according to claim 8, wherein the plurality of examples associated with each of the plurality of labels are received in a plurality of files, where each of the plurality of files includes the plurality of examples of only one label.

14. A method according to claim 13, wherein the filename of each of the plurality of files including the plurality of examples of only one label comprises the label.

15. A non-transitory medium storing processor-executable program code, the program code executable to cause a system to:
receive a plurality of data samples for training a machine learning model from a user;
receive a plurality of examples associated with each of a plurality of ground truth labels for training a machine learning model from the user;
for each of the plurality of data samples:
identify all examples of the plurality of examples within the data sample;
for each identified example, determine an associated one of the plurality of labels and a location of the example in the data sample, and
annotate the data sample with the associated one of the plurality of labels and the location; and
return the annotated data sample to the user.

16. A medium according to claim 15, wherein determination of the location comprises determination of a start index and an end index of the example within the data sample, and wherein the data sample is annotated with the start index and the end index.

17. A medium according to claim 15, wherein the plurality of data samples are received via a first application programming interface, and
wherein the plurality of examples associated with each of a plurality of labels are received via a second application programming interface.

18. A medium according to claim 17, wherein the plurality of data samples are received within a first file,
wherein the plurality of examples associated with each of the plurality of labels are received in a plurality of files, where each of the plurality of files includes the plurality of examples of only one label, and
wherein the filename of each of the plurality of files including the plurality of examples of only one label comprises the label.

19. A system according to claim 15, wherein the plurality of examples associated with each of the plurality of labels are received in a plurality of files, where each of the plurality of files includes the plurality of examples of only one label.

20. A system according to claim 19, wherein the filename of each of the plurality of files including the plurality of examples of only one label comprises the label.
